(19) United States
(12) Patent Application Publication
(10) Pub. No.: US 2003/0075700 A1
(43) Pub. Date: Apr. 24, 2003

(54) Tank valve

(76) Inventors: Erick Girouard, Guelph (CA); Christopher Green, Toronto (CA)

Correspondence Address: GOWLING LAFLEUR HENDERSON LLP, COMMERCE COURT WEST, SUITE 4900, TORONTO, ON, M5L 1J3, CA

(21) Appl. No.: 09/983,456

(22) Filed: Oct. 24, 2001

(51) Int. Cl. F16K 31/124

(52) U.S. Cl. 251/30.02; 251/38; 251/144

(57) ABSTRACT

The present invention provides a valve assembly comprising a first passageway including a first port, a second port defining a restrictive orifice, a third port, and a first valve seat defining a first orifice, a second passageway extending from the third port and including a minimum cross-sectional area defined by a minimum orifice, and also including a second valve seat defining a second orifice, a first piston sealingly disposed in the first passageway between (i) the first port and (ii) the second and the third ports, and configured to seal the first orifice, and a second piston disposed in the second passageway between the third port and the second valve seat, and configured to seal the second orifice, wherein the minimum cross-sectional area of the minimum orifice is larger than the cross-sectional area of the restrictive orifice, and wherein the second orifice is characterized by a smaller cross-sectional area than that of the first orifice. The present invention further provides a vessel for containing pressurized gas comprising a nozzle, and a valve assembly comprising a first passageway including a first port, a second port defining a restrictive orifice, a third port, and a first valve seat defining a first orifice, a second passageway extending from the third port and including a minimum cross-sectional area defined by a minimum orifice, and also including a second valve seat defining a second orifice, a first piston sealingly disposed in the first passageway between (i) the first port and (ii) the second and the third ports, and configured to seal the first orifice, and a second piston disposed in the second passageway between the third port and the second valve seat, and configured to seal the second orifice, wherein the minimum cross-sectional area of the minimum orifice is larger than the cross-sectional area of the restrictive orifice, and wherein the second orifice is characterized by a smaller cross-sectional area than that of the first orifice.

### FIELD OF INVENTION

This invention relates to tank valves, and particularly to two-stage type tank valves.

### BACKGROUND OF THE INVENTION

Because of environmental concerns and emissions laws and regulations, manufacturers of motor vehicles are searching for a clean burning and cost efficient fuel to use as an alternative to gasoline. Natural gas is one candidate for such a purpose, and many vehicles have been converted to natural gas as a fuel source. Typically, the natural gas is stored on board the vehicle in compressed form in one or more pressurized cylinders.

Gas flow from such pressured cylinders are controlled by valves. One major concern is the vulnerability of such gas valves to crash damage. If the vehicle is involved in an accident, the gas valve must not fail in an unsafe or catastrophic manner. To this end, internally-mounted gas valves have been designed to mitigate such unsafe or catastrophic conditions. Examples of such valves are disclosed in Wadensten et al., U.S. Pat. No. 4,197,966, Wass et al., U.S. Pat. No. 5,197,710, and Borland et al., U.S. Pat. No. 5,562,117.

Although both Wass and Borland disclose internally-mounted gas valves, these gas valves suffer from the fact that they are relatively slow in opening when downstream pressure is relatively low. Further, although the gas valve disclosed in Wadensten can be characterized as fast opening relative to the gas valves disclosed in Wass and Borland, Wadensten's valve design is complicated, requiring a relatively large number of components.

### SUMMARY OF THE INVENTION

The present invention provides a valve assembly comprising a first passageway including a first port, a second port defining a restrictive orifice characterized by a restrictive cross-sectional area, a third port, and a first valve seat defining a first orifice characterized by a first orifice cross-sectional area, a second passageway extending from the third port and including a second valve seat defining a second orifice characterized by a second orifice cross-sectional area, first piston sealingly disposed in the first passageway between (i) the first port and (ii) the second and the third ports, and configured to seal the first orifice, a second piston disposed in the second passageway between the third port and the second valve seat, and configured to seal the second orifice, wherein, over time, gas pressure decreases within the first passageway between (i) the first piston and (ii) the second and the third ports, when the first orifice is sealed by the first piston and the second orifice is in communication with the third port and the second port is in communication with a gas or gaseous mixture supply.

The present invention additionally provides a valve assembly comprising a first passageway including a first port, a second port defining a restrictive orifice characterized by a restrictive cross-sectional area, a third port, and a first valve seat defining a first orifice characterized by a first orifice cross-sectional area, a second passageway extending from the third port and including a minimum cross-sectional area defined by a minimum orifice, and also including a second valve seat defining a second orifice characterized by a second orifice cross-sectional area, a first piston sealingly disposed in the first passageway between (i) the first port and (ii) the second and the third ports, and configured to seal the first orifice, and a second piston disposed in the second passageway between the third port and the second valve seat, and configured to seal the second orifice, wherein the respective cross-sectional areas of the restrictive orifice and the minimum orifice are configured such that a first mass flow rate of gas or gaseous mixture through the third port is greater than a second mass rate of gas or gaseous mixture through the second port, when the first orifice is sealed by the first piston and the second orifice is in communication with the third port and the second port is in communication with a gas or gaseous mixture supply.

The present invention also provides a valve assembly comprising a passageway including a first port, a second port defining a restrictive orifice, a third port, and a first valve seat defining a first orifice, a second passageway extending from the third port and including a minimum cross-sectional area defined by a minimum orifice, and also including a second valve seat defining a second orifice, a first piston sealingly disposed in the first passageway between (i) the first port and (ii) the second and the third ports, and configured to seal the first orifice, and a second piston disposed in the second passageway between the third port and the second valve seat, and configured to seal the second orifice, wherein the minimum cross-sectional area of the minimum orifice is larger than the cross-sectional area of the restrictive orifice, and wherein the second orifice is characterized by a smaller cross-sectional area than that of the first orifice.

The present invention further provides a vessel containing pressurized gas comprising a nozzle, and a tank valve assembly comprising a first passageway including a first port, a second port defining a restrictive orifice, a third port, and a first valve seat defining a first orifice, a second passageway extending from the third port and including a minimum cross-sectional area defined by a minimum orifice, and also including a second valve seat defining a second orifice, a first piston sealingly disposed in the first passageway between (i) the first port and (ii) the second and the third ports, and configured to seal the first orifice, and a second piston disposed in the second passageway between the third port and the second valve seat, and configured to seal the second orifice, wherein the minimum cross-sectional area of the minimum orifice is larger than the cross-sectional area of the restrictive orifice, and wherein the second orifice is characterized by a smaller cross-sectional area than that of the first orifice.

In one aspect, the first piston, about its periphery, carries a sealing member to effect sealing engagement with the first passageway.

In another aspect, the first piston is urged towards the first valve seat by a first resilient member.

In another aspect, the first piston includes a first piston valve configured to engage the first valve seat to thereby seal the first orifice.

In yet another aspect, the second piston includes a second piston valve configured to engage the second valve seat to thereby seal the second orifice.

In another aspect, the present invention further comprises an actuator to urge the second piston away from the second valve seat.

In yet another aspect, the actuator is a solenoid coil.

In another aspect, wherein the second piston is comprised of magnetic material.

In another aspect, the valve assembly further comprises a sealing member disposed between the first piston and the first passageway, thereby effecting sealing disposition of the first piston within the first passageway.

In another aspect, the second port is in communication with the third port.

In yet another aspect, the first port and the second port are disposed in communication with a common source of fluid pressure, such as the interior of a pressure vessel.

In yet a further aspect, the valve assembly is bi-directional.

### BRIEF DESCRIPTION OF THE DRAWINGS

The invention will be better understood when consideration is given to the following detailed description thereof. Such description makes reference to the annexed drawings wherein:

FIG. 1 is a sectional elevation view of an embodiment of a valve assembly of the present invention showing the valve assembly in a closed position;

FIG. 2 is a sectional elevation view of the valve assembly illustrated in FIG. 1, showing the valve assembly in a transition position;

FIG. 3 is a sectional elevation view of the valve assembly illustrated in FIG. 1, showing the valve assembly in an open position; and

FIG. 4 is a sectional elevation view of the valve assembly illustrated in FIG. 1, showing the valve assembly in a fill position.

### DETAILED DESCRIPTION

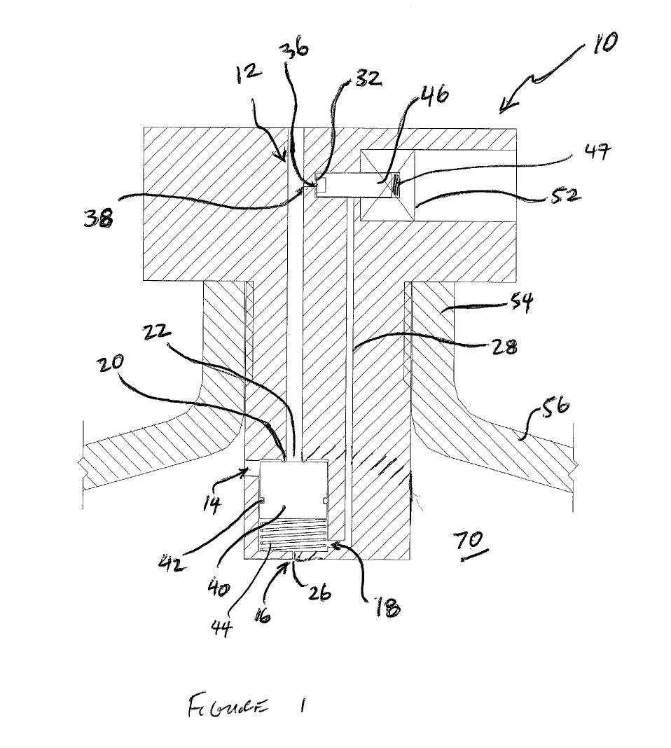

FIG. 1 illustrates a valve assembly comprising a first passageway 12 including a first port 14, a second port 16, a third port 18, and a first valve seat 20 defining a first orifice 22. The second port 24 defines a restrictive orifice 26.

A second passageway 28 extends from the third port 18 and includes a minimum cross-sectional area defined by a minimum orifice 35. The second passageway 28 further includes a second valve seat 32 defining a second orifice 36.

In one embodiment, the first passageway 12 includes a fourth port 38 disposed remote from the second port 16 relative to the first orifice 22, and the second passageway 28 extends from the third port 18 and into the fourth port 38.

A first piston 40 is sealingly disposed in the first passageway 12 between (i) the first port 14 and (ii) the second and third ports 16, 18. In one embodiment, a sealing member 42 is disposed between the first piston 40 and the first passageway 12, thereby effecting the sealing disposition of the first piston 40 within the first passageway 12. In one embodiment, the sealing member 42 is carried about the periphery of the first piston 40. In this respect, gas flow from the first port 14 to the second and third ports 16, 18 is prevented.

The first piston 40 is configured to seal the first orifice 22. The first piston 40 includes a first piston valve 43 configured to engage the first valve seat 20 to thereby seal the first orifice 22. The first piston 40 is biassed towards the first valve seat 20, to seal the first orifice 22, by a first resilient member 44, such as a spring. The first resilient member 44 bears against the first piston 40, and thereby urges the first piston 40 towards the first valve seat 20.

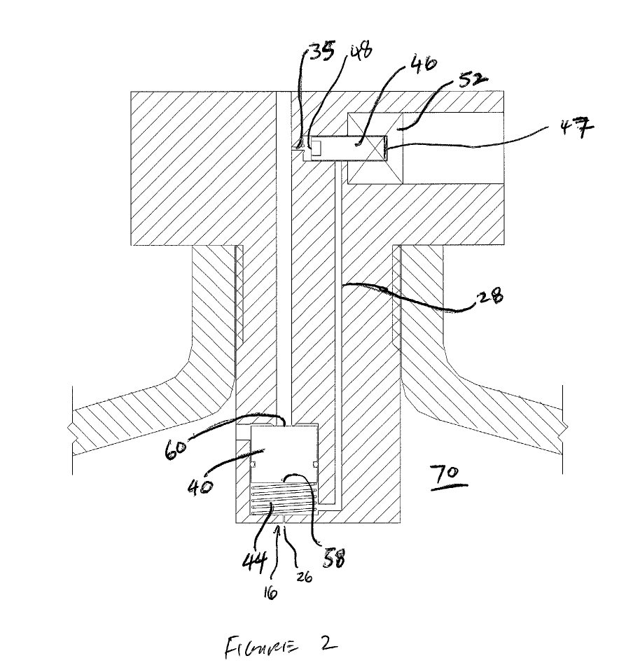

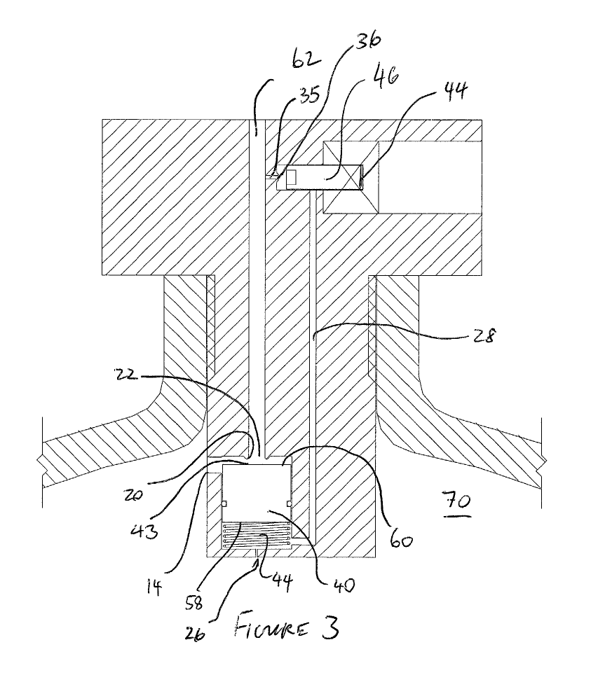

A second piston 46 is disposed in the second passageway 28 between the third port 18 and the second valve seat, and is configured to seal the second orifice 36. The second piston 46 includes a second piston valve 48 configured to engage the second valve seat 32 to thereby seal the second orifice 36. The second piston 46 is biassed towards the second valve seat 32 second resilient member 47, such as a spring. In a second piston first position (see FIG. 1), the second piston 46 is seated against the second valve seat 32, thereby sealing the second orifice 36. In a second piston second position (see FIG. 2 or 3), the second piston 46 is unseated from the second valve seat 32, or spaced from the second valve seat 32, thereby unsealing the second orifice 36 and facilitating communication between the third port 18 and the second orifice 36 and, therefore, gas flow through the second orifice 36.

An actuator 52 is provided and configured to actuate and urge the second piston 46 away from the second valve seat 32, to thereby unseal or open the second orifice 36. In one embodiment, the actuator 52 is a solenoid coil. The solenoid coil is provided to apply electromagnetic forces on second piston 46 by external actuation, thereby opposing the forces of the second resilient member 47 and gas pressure urging the second piston 46 towards the second valve seat 32. In this respect, the solenoid coil is provided to urge the second piston 46 away from the second valve seat 32. To facilitate this action, second piston 46 is comprised of magnetic material.

In one embodiment, the valve assembly is configured such that, over time, gas pressure decreases within the first passageway 12 between (i) the first piston 40 and (ii) the second and the third ports 16, 18, when the first orifice 22 is sealed by the first piston 40 and second piston 46 is in the second piston second position and the second port is in communication with a gas or gaseous mixture supply, such as a gas or gaseous mixture within interior 70 of a vessel 56.

In another embodiment, the valve assembly is configured such that a first mass flow rate of gas or gaseous mixture through the third port 18 is greater than a second mass flow rate of gas or gaseous mixture through the second port 16, when the first orifice 22 is sealed by the first piston 40 and the second piston 46 is in the second piston second position and the second port is in communication with a gas or gaseous mixture supply, such as gas within interior 70 of a vessel 56.

To facilitate faster opening of the valve assembly 10, the orifices are co-operatively sized. In this respect, in one embodiment, the cross-sectional area of the second orifice 36 is smaller than the first orifice 22, so that the force necessary to unseat the second piston 46 from its corresponding valve seat 32 is smaller than the force necessary to unseat the first piston 40 from its corresponding valve seat 20. Further, as a necessary incident, the restrictive orifice 26 is characterized by a smaller cross-sectional area than that of the first orifice 22. In co-operation, the cross-sectional area of the minimum orifice is larger than the cross-sectional area of the restrictive orifice 26, so that a first rate of gas flow through the third port 18 is faster than a second rate of gas flow through second port 16 when the second piston is in the second piston second position. In this respect, the rate of discharge of gas disposed within the first passageway 12, between (i) the first piston 40 and (ii) the second and the third ports 16, 18, through third port 18 is faster than the rate of entry of gas into this same space within the first passageway 12. As a result, over time, gas pressure decreases within the first passageway 12 between (i) the first piston 40 and (ii) the second and the third ports 16, 18, when the first orifice 22 is sealed by the first piston 40 and the second piston 46 is in the second piston second position.

In one embodiment, the valve assembly 10 is installed within a nozzle 54 of a vessel 56 containing gas under pressure in its interior 70, and thereby regulates gas flow in and out of the vessel. In this respect, a vessel outlet is provided, extending from the first orifice 22. The first and second ports 14, 16 are disposed in communication with a common source of fluid pressure, namely the interior 70.

FIGS. 1, 2, and 3 illustrate an embodiment of the valve assembly 10 in various conditions of operation. FIG. 1 illustrates the valve assembly 10 in a closed position. In this condition, the solenoid coil 52 is not energized. Under these circumstances, gaseous pressure forces and forces attributable to the resilient member 44, in concert, act upon the first piston 40 and urge the first piston 40 against the first valve seat 20 to seal the first orifice 22. Gaseous forces also act upon the second piston 46 and urge the second piston 46 against the second valve seat 32 to seal the second orifice 36.

FIG. 2 illustrates the valve assembly 10 in a transition position. The transition position is realized immediately after the solenoid coil 52 is energized. Moments after the solenoid coil 52 is energized, electromagnetic forces produced thereby act upon the second piston 46. These forces overcome the forces urging the second piston 46 towards the second valve seat 32 (i.e. those applied by the second resilient member 47 and the gas pressure in the second passageway 28). As a result, the second piston 46 is urged to move away from the second valve seat 32, thereby unsealing or opening the second orifice 36. By opening the second orifice 36, gas begins to escape from the third port 18 and through the second passageway 28. Because the restrictive orifice 26 is sized in the manner explained above, gaseous pressure at a second end 58 of the first piston 40 begins to drop. However, in the transition condition, gaseous pressure at the second end 58 of the first piston 40 has not dropped sufficiently to be overcome by gaseous pressure forces acting upon an opposite first end 60 of first piston 40.

FIG. 3 illustrates the valve assembly 10 in an open position. In this condition, gaseous pressure at the second end 58 of the first piston 40 has dropped further. At this point, gaseous pressure forces acting upon the second end 58 of the first piston 40 have sufficiently subsided to have been overcome by the gaseous pressure forces acting upon the first end 60 of the first piston 40. As a result, first piston valve 42 becomes unseated from the first valve seat 20, thereby creating a flow path in the conduit from the first port 14, through the first orifice 22, and through the tank outlet 62.

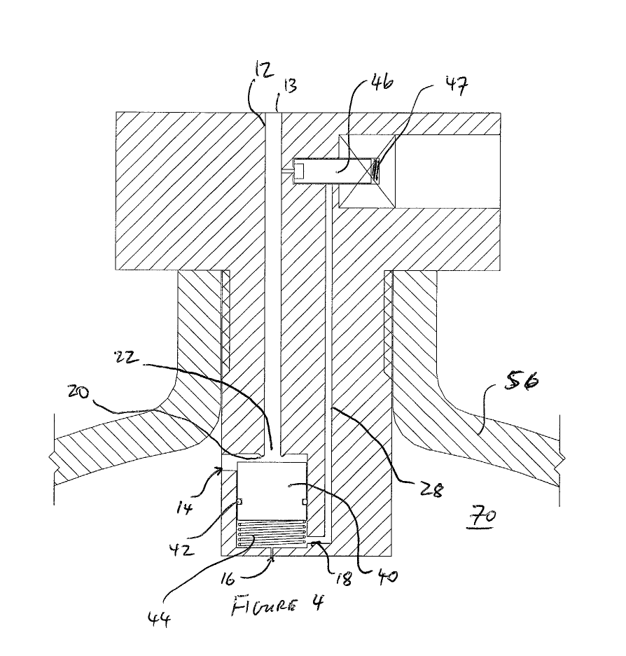

FIG. 4 illustrates the valve assembly 10 in a fill position, and particularly illustrates the flowpath taken through valve assembly 10 during filling of vessel 56 with a gas or gaseous mixture. Gas enters through port 13. From port 13, gas flows via the first passageway 12, and presses upon the first piston valve 43 and forces the first piston 40 to become unseated from the first valve seat 20. As a result, an uninterrupted flowpath is created between port 13 and port 14 and, therefore, the interior 70 of the vessel 56. When the filling operation is complete, the first resilient member 44 exerts sufficient force on the first piston 40, to cause first piston valve 43 to engage the first valve seat 20, and thereby seal the first orifice 22.

Although the disclosure describes and illustrates preferred embodiments of the invention, it is to be understood tat the invention is not limited to these particular embodiments. Many variations and modifications will now occur to those skilled in the art. For definition of the invention, reference is to be made to the appended claims.

1. A valve assembly comprising:
a first passageway including a first port, a second port defining a restrictive orifice characterized by a restrictive cross-sectional area, a third port, and a first valve seat defining a first orifice characterized by a first orifice cross-sectional area;
a second passageway extending from the third port and including a second valve seat defining a second orifice characterized by a second orifice cross-sectional area;
a first piston sealingly disposed in the first passageway between (i) the first port and (ii) the second and the third ports, and configured to seal the first orifice;
a second piston disposed in the second passageway between the third port and the second valve seat, and configured to seal the second orifice;
wherein, over time, gas pressure decreases within the first passageway between (i) the first piston and (ii) the second and the third ports, when the first orifice is sealed by the first piston and the second orifice is in communication with the third port and the second port is in communication with a gas or gaseous mixture supply.

2. The valve assembly as claimed in claim 1, wherein the first orifice cross-sectional area is larger than the second orifice cross sectional area.

3. The valve assembly as claimed in claim 2, wherein, about its periphery, the first piston carries a sealing member to effect sealing engagement with the first passageway.

4. The valve assembly as claimed in claim 3, wherein the first piston is urged towards the first valve seat by a first resilient member.

5. The valve assembly as claimed in claim 4, wherein the first piston includes a first piston valve configured to engage the first valve seat to thereby seal the first orifice.

6. The valve assembly as claimed in claim 5, wherein the second piston includes a second piston valve configured to engage the second valve seat to thereby seal the second orifice.

7. The valve assembly as claimed in claim 6, further comprising an actuator to urge the second piston away from the second valve seat.

8. The valve assembly as claimed in claim 7, wherein the actuator is a solenoid coil.

9. The valve assembly as claimed in claim 8, wherein the second piston is comprised of magnetic material.

10. The valve assembly as claimed in claim 2, further comprising a sealing member disposed between the first piston and the first passageway, thereby effecting sealing disposition of the first piston within the first passageway.

11. The valve assembly as claimed in claim 2, wherein the second port is in communication with the third port.

12. The valve assembly as claimed in claim 2, wherein the first port and the second port are disposed in communication with a common source of fluid pressure.

13. A vessel for containing pressurized gas comprising:
a nozzle; and
a valve assembly comprising:
a first passageway including a first port, a second port defining a restrictive orifice characterized by a restrictive cross-sectional area, a third port, and a first valve seat defining a first orifice characterized by a first orifice cross-sectional area;
a second passageway extending from the third port and including a minimum cross-sectional area defined by a minimum orifice, and also including a second valve seat defining a second orifice characterized by a second orifice cross-sectional area;
a first piston sealingly disposed in the first passageway between (i) the first port and (ii) the second and the third ports, and configured to seal the first orifice; and
a second piston disposed in the second passageway between the third port and the second valve seat, and configured to seal the second orifice;
wherein, over time, gas pressure decreases within the first passageway between (i) the first piston and (ii) the second and the third ports, when the first orifice is sealed by the first piston and the second orifice is in communication with the third port;
wherein the valve assembly is coupled to the nozzle.

14. The vessel as claimed in claim 13, wherein, about its periphery, the first piston carries a sealing member to effect sealing engagement with the first passageway.

15. The vessel as claimed in claim 14, wherein the first piston is urged towards the first valve seat by a first resilient member.

16. The vessel as claimed in claim 15, wherein the first piston includes a first piston valve configured to engage the first valve seat to thereby seal the first orifice.

17. The vessel as claimed in claim 16, wherein the second piston includes a second piston valve configured to engage the second valve seat to thereby seal the second orifice.

18. The vessel as claimed in claim 17, further comprising an actuator to urge the second piston away from the second valve seat.

19. The vessel as claimed in claim 18, wherein the actuator is a solenoid coil.

20. The vessel as claimed in claim 19, wherein the second piston is comprised of magnetic material.

21. The vessel as claimed in claim 20, further comprising a sealing member disposed between the first piston and the first passageway, thereby effecting sealing disposition of the first piston within the first passageway.

22. The valve assembly as claimed in claim 13, wherein the second port is in communication with the third port.

23. The vessel as claimed in claim 13, wherein the first port and the second port are disposed in communication with the interior of the vessel.

24. The valve assembly as claimed in claim 13, wherein the first orifice cross-sectional area is larger than the second orifice cross-sectional area.

25. A valve assembly comprising:
a first passageway including a first port, a second port defining a restrictive orifice characterized by a restrictive cross-sectional area, a third port, and a first valve seat defining a first orifice characterized by a first orifice cross-sectional area;
a second passageway extending from the third port and including a minimum cross-sectional area defined by a minimum orifice, and also including a second valve seat defining a second orifice characterized by a second orifice cross-sectional area;
a first piston sealingly disposed in the first passageway between (i) the first port and (ii) the second and the third ports, and configured to seal the first orifice; and
a second piston disposed in the second passageway and configured to seal the second orifice;
wherein the respective cross-sectional areas of the restrictive orifice and the minimum orifice are configured such that a first mass flow rate of gas or gaseous mixture through the third port is greater than a second mass flow rate of gas or gaseous mixture through the second port, when the first orifice is sealed by the first piston and the second orifice is in communication with the third port and the second port is in communication with a gas or gaseous mixture supply.

26. A valve assembly comprising:
a first passageway including a first port, a second port defining a restrictive orifice characterized by a restrictive cross-sectional area, a third port, and a first valve seat defining a first orifice characterized by a first orifice cross-sectional area;
a second passageway extending from the third port and including a minimum cross-sectional area defined by a minimum orifice, and also including a second valve seat defining a second orifice characterized by a second orifice cross-sectional area;
a first piston sealingly disposed in the first passageway between (i) the first port and (ii) the second and the third ports, and configured to seal the first orifice; and
a second piston disposed in the second passageway between the third port and the second valve seat, and configured to seal the second orifice;
wherein the first orifice cross-sectional area is larger than the second orifice cross-sectional area, and wherein the minimum cross-sectional area is larger than the restrictive cross-sectional area.
